(19) United States
(12) Patent Application Publication
(10) Pub. No.: US 2017/0270502 A1
(43) Pub. Date: Sep. 21, 2017

(54) SENSOR SYSTEMS AND METHODS

(71) Applicant: John Henry FINBOW, Sudbury (GB)

(72) Inventor: John Henry FINBOW, Sudbury (GB)

(21) Appl. No.: 15/294,081

(22) Filed: Oct. 14, 2016

Related U.S. Application Data
(60) Provisional application No. 62/309,851, filed on Mar. 17, 2016.

(51) Int. Cl. G06Q 20/20; G06K 7/14; G06K 19/06

(52) U.S. Cl. CPC G06Q 20/208; G06K 19/06037; G06K 7/1417

(57) ABSTRACT

A sensor system comprises a sensor housing, a sensor contained within said housing, said sensor being configured to detect one or more characteristics of a passive tag or of a physical object representative of a specific product; wherein the sensor system further comprises a user interface, a data store for storing signals detected by said sensor, and a processor for processing said detected signals; the processor being further configured to present via the user interface the option of purchasing a specific product to the user of the sensor, the signals being simultaneously representative of the product and of a point of retail where detection was initiated, wherein said system further comprises a purchasing system for purchasing the specific product; and a communication link between the purchasing system and a brand owner who facilitates the dispatch of the specific product to a destination specified by the user of the sensor.

### CLAIM OF PRIORITY UNDER 35 U.S.C. §119

The present application for patent claims the benefit of U.S. Provisional Application No. 62/309,851, entitled “Virtual Store,” filed Mar. 17, 2016, which is expressly incorporated herein by reference in its entirety.

### FIELD OF THE INVENTION

The invention relates to a sensor system, a method of detection and a method of delivering goods and/or services.

The invention relates to a method and system to allow users to order goods and/or services, which may not necessarily be and in certain embodiments are not typically physically available from a retail outlet or a retail point as a consequence of a user's visit to a retail outlet.

### BACKGROUND TO THE INVENTION

In the field of product delivery and logistics, the traditional model of retailers needing to allow sufficient shelf space for each one of the potential products that they intend to sell has been progressively replaced by complex systems including trend analysis, purchasing software and the growth of online retailers. Nevertheless, online retailers often struggle to convincingly portray their products on user interfaces. Often members of the public prefer to interact specifically with certain goods in retail outlets to assess products in detail in terms of quality and functionality. Despite these promotional efforts being desired by members of the public, retail outlets fail to receive any compensation for their promotional efforts because, for example, consumers go and buy online. Consequently, the products promoted by retailers are increasingly selective. Certain embodiments of the invention seek to overcome the problems faced by retailers and brand owners by providing systems and methods which provide a bridge between physical outlets and specific products which would not ordinarily be in stock whilst having a secondary but important virtuous effect of facilitating the compensation of retailers for their promotional activities whilst at the same time safeguarding the interests of brand owners and potentially in certain embodiments enhancing the network of retailers with which they collaborate.

### SUMMARY OF THE INVENTION

In a first broad independent aspect, the invention provides a sensor system comprising a sensor housing, a sensor contained within said housing, said sensor being configured to detect one or more characteristics of a passive tag or of a physical object representative of a specific product optionally without being itself a product; wherein the sensor system further comprises a user interface, a data store for storing signals detected by said sensor, and a processor for processing said detected signals; said processor being further configured to present via said user interface the option of purchasing a specific product to the user of said sensor, said signals being simultaneously representative of the product and of a point of retail where detection was initiated, wherein said system further comprises a purchasing system for purchasing said specific product; and a communication link between said purchasing system and a brand owner who facilitates the dispatch of said specific product to a destination specified by the user of said sensor.

This configuration is particularly advantageous because in certain embodiments it reduces the amount of stock a retailer must purchase for a particular point of retail. It nevertheless facilitates a purchase at a point of retail for which the retailers may receive monetary compensation to reflect their promotional activities. In certain embodiments, it also simplifies the process of delivery for the brand owner as it may facilitate an increase in the number of points of retail associated with the brand without the logistical requirements of providing stock to the point of retail. Traditionally when increasing the network of potential brand ambassadors, the systems require significant increases in costs for supplying stock as the network increases in size. By contrast, in certain embodiments, despite a wider network of brand ambassadors, the system allows the complexity of the logistics associated with the delivery of goods and/or services to be substantially contained. Other advantages will become apparent when examining more specific embodiments of the invention.

In a subsidiary aspect, upon the completion of a purchase, the system automatically communicates the completion to both the retailer associated with the point of retail and to the brand owner.

This further improvement is particularly advantageous because both the retailer and the brand owner are simultaneously engaged which further optimizes the logistics associated with the product promotion and delivery. This system also improves the timing of the interaction between brand owner and retailer.

In a subsidiary aspect, the sensor incorporates a camera for capturing an image of the passive tag or of the object, and an optical recognition system for determining signals representative of the specific product and of the point of retail.

In certain embodiments, this configuration is particularly advantageous for converting physical objects with which users can readily interact in a retail outlet for example into a digital signal which may then be processed via a digital communication interface to simplify the purchasing and delivery processes. This configuration also provides accuracy and simplification in terms of determining which retailer has effectively promoted the brand and therefore identifying which retailer is entitled to compensation.

In a subsidiary aspect, the optical recognition system determines the shape of the perimeter of an object and matches it against a pre-determined shape.

This configuration is particularly advantageous in terms of the optimal transcription of a user's interaction with a physical object into a digital request for purchase and delivery of a specific product.

In a subsidiary aspect, the image incorporates a plurality of pixels which correspond uniquely to a specific product and to a particular point of retail.

In terms of simplification of the processing of a physical product indicator into a digital request for purchasing and distribution, this configuration provides enhanced accuracy of product identification whilst at the same time providing accurate identification of a particular point of retail.

In a subsidiary aspect, the sensor system further comprises a global position sensor for determining the point of retail and the processor associates said determined point of retail with other characteristics representative of a specific product.

This configuration is particularly advantageous since in a certain embodiment it avoids the requirement of necessarily tailoring each passive tag with respect to a point of retail. In effect, the system derives the signal representative of the product and of the point of retail by enquiring of the on-board global position sensor to determine the relevant geographic coordinates and thereafter by looking up a particular retailer associated with the specific geographic coordinates, the system correctly associates a particular retailer responsible for the promotion which attracted the user to interact with the system.

In a subsidiary aspect, the data store stores a plurality of signals detected by the sensor and allows the user interface to select any one of the specific products for purchasing after a predetermined time has lapsed since the determination of the specific product and its point of retail.

In certain embodiments, this configuration is particularly advantageous in order to allow the completion of the purchase to arise at a deferred period of time. This may for example facilitate the completion of a purchase when no wireless network access is available in a given point of retail. This provision would also overcome the problem of potential weak wireless network signals due to building infrastructure and wireless network malfunctions.

In a subsidiary aspect, the data store stores a plurality of signals detected by the sensor and presents the latest detected product and its most recently associated point of retail.

In certain embodiments, the user may have sensed multiple identical specific products in a plurality of outlets. This configuration allows a weighting to be applied towards the latest detected product in order to correctly provide compensation for the retailer who closed the sale. Other embodiments may envisage each one of the stored points of retail to receive a proportion of the compensation for their respective promotional campaigns.

In a subsidiary aspect, the invention is embodied in a driverless vehicle comprising a sensor system according to any of the preceding aspects.

This configuration is particularly advantageous because it may allow the interaction between a vehicle and passive tags to initiate the purchasing system and also to be potentially employed for the collection of a specific product on behalf of a user. In certain embodiments, therefore both the initiation of the purchase and the completion of the delivery may therefore be undertaken by the driverless vehicle.

In a further independent aspect, the invention provides a method of detection comprising the steps of:
providing a sensor housing and a sensor contained within said housing,
detecting one or more characteristics of a passive tag or of a physical object representative of a specific product optionally without being itself a product;
providing a user interface, and a data store for storing signals detected by said sensor; said signals being simultaneously representative of the product and of a point of retail where detection was initiated;
processing said detected signals;
presenting via said user interface the option of purchasing a specific product to the user of said sensor;
providing a purchasing system for purchasing said specific product; and
causing said purchasing system to communicate via a communication link with a brand owner to facilitate the dispatch of said specific product to a destination specified by the user of said sensor.

In a subsidiary aspect in accordance with the preceding aspect, the method of detection comprises upon completion of a purchase, the further step of automatically communicating the completion to both the retailer associated with the point of retail and the brand owner.

In a subsidiary aspect, the method of detection comprises the further steps of capturing an image of said passive tag or of said object and employing optical recognition to determine signals representative of said specific product and of said point of retail.

In a subsidiary aspect, the method of detection comprises the step of determining the shape of the perimeter of an object and matching it against a pre-determined shape.

In a subsidiary aspect, the method comprises the step of correlating the pixels of a captured image against a pre-determined dataset uniquely representative of both a specific product and its point of retail.

In a further subsidiary aspect, the method further comprises the step of determining the position of the sensor in a set of geographic or geospatial coordinates in order to determine the point of retail and associating the determined point of retail with the specific product.

In a further subsidiary aspect, the method further comprises the steps of storing a plurality of signals detected by the sensor and allowing the user interface to select any one of the specific products for purchasing after a predetermined time has lapsed since the determination of said specific product and its point of retail.

In a further subsidiary aspect, the method further comprises the steps of storing a plurality of signals detected by said sensor and presenting the latest detected product and its most recently associated point of retail.

According to a further aspect of the invention, there is provided a method of delivering goods to a user comprising one or more of the following steps:

i) receiving at a first server identification data containing the identity of goods that a user wishes to acquire;

ii) causing the first server to return results data providing one or more sources from which the goods can be obtained;

iii) causing the first server to present a shopping cart to the user from which the user can arrange a purchase of the goods; and

iv) causing the first server to communicate with a second server by sending order data thereto.

This configuration is particularly advantageous for similar reasons as those outlined with respect to the first broad independent aspect. In particular, by employing a first server, in certain embodiments, the interests of the sources or the retailers from which the goods can be obtained may be not only protected but enhanced, whilst at the same time by efficiently communicating with the second server, the interests of a brand owner are also enhanced in terms of minimizing the amount of sitting stock with retailers whilst allowing an efficient delivery of the specific products to a user.

Reference to a machine readable medium herein may mean any of the following: a memory (such as a USB flash drive; an SD card; a CF card); a hard drive; an SSD drive; a CD ROM/RAM; a DVD ROM/RAM (including 9−R/−RW and +R/+RW); a transmitted signal; a wire; an Internet download, or the like.

In a further subsidiary aspect, the identification data comprises any of the following: the identification of the goods; the location at which the identification data was received.

The implementation of identification data containing certain embodiments both the identification of the goods which are being sought and the location at which the identification data was received allows accurate determination of the retailers which may then receive compensation for their promotional efforts. It also allows a network of retailers to be considerably expanded when compared to conventional retail networks.

In a further subsidiary aspect, in order to present the results data to the user, the first server is arranged to perform a search to locate the goods.

This configuration is particularly advantageous because, in certain embodiments, the search may be handled for a wide variety of specific products and for a wide variety of retailers on a common platform.

In a further subsidiary aspect, in order to present the results data to the user, the first server uses a database to which it has access.

In certain embodiments, this configuration is particularly advantageous in terms of rapid presentation of the specific product details for effective assessment by the user.

In a further subsidiary aspect, the order data specifies the address to which the goods should be sent.

In certain embodiments, this is particularly advantageous because it would allow data from a first server to be readily integrated with an API (application program interface) of a brand owner which could then efficiently organize the delivery of a specific product to a specified address.

In a further subsidiary aspect, the preceding methods or systems comprise a server which is arranged to provide the method of any preceding aspect.

In a further subsidiary aspect, the invention is embodied in a machine readable medium containing instructions which when read by a computer cause that computer to perform as the first server.

Certain embodiments of the invention are preferably implemented using a computing engine which is most effectively used, pursuant to exemplary embodiments of the present disclosure, for controlling the operation of a real complex delivery system, for example wherein the complex system interacts with real physical variables and one or more real physical processes, for example one or more real physical processes that are susceptible to experiencing variations that can influence operation of the real physical processes. Examples of such a real complex systems include:
(a) A driverless automobile or delivery vehicle, namely an automatic computer-steered vehicle, wherein a user input defines a spatial route within a road network and a destination for the route along which the vehicle is required to travel, and wherein sensors of the driverless automobile or vehicle are operable to sense road conditions and other road vehicles.
(b) Industrial processes which handle for example plants and perishable food produce which require extensive treatment for optimum growth and may therefore be difficult to provide in conventional outlet environments; and
(c) A logistics and transportation system, wherein sensors gather in information regarding assets such as the products and/or vehicles, wherein a user is able to input commands to the logistics system, and wherein, for example route of dispatch, vehicles for dispatch, choice of warehouses, or delivery outlets and so forth. The sensor system may be implemented by a computing engine which is capable of providing computations to enable the logistics system to function in a more optimal manner.

### DESCRIPTION OF THE FIGURES

There now follows by way of example only, a detailed description of several embodiments of the invention, of which:

FIG. 1 schematically shows a part of a sensor activated system.

FIG. 2 show a selection of the primary components of the mobile unit.

FIG. 3 shows a flow chart of an embodiment of a part of the process implemented by the system.

FIG. 4 shows a flow chart of a further embodiment of a part of the process implemented by the system.

FIG. 5 shows a flow chart of a further embodiment of a part of the process implemented by the system.

FIG. 6 schematically shows a network arranged to perform an embodiment.

FIG. 7 shows a flow chart outlining a method of an embodiment.

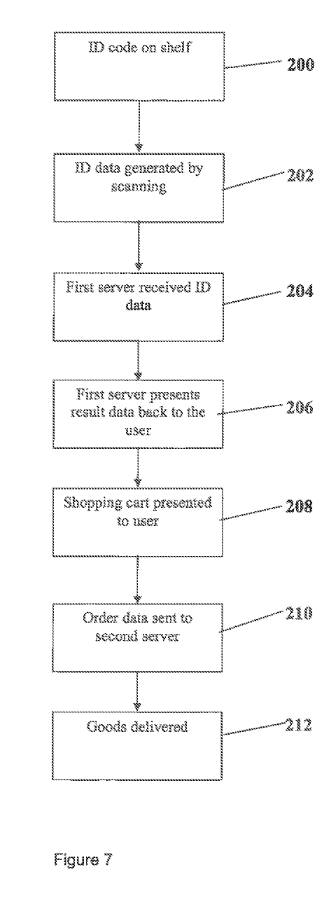

### DETAILED DESCRIPTION

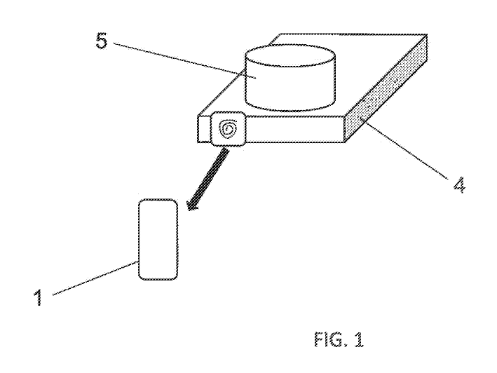

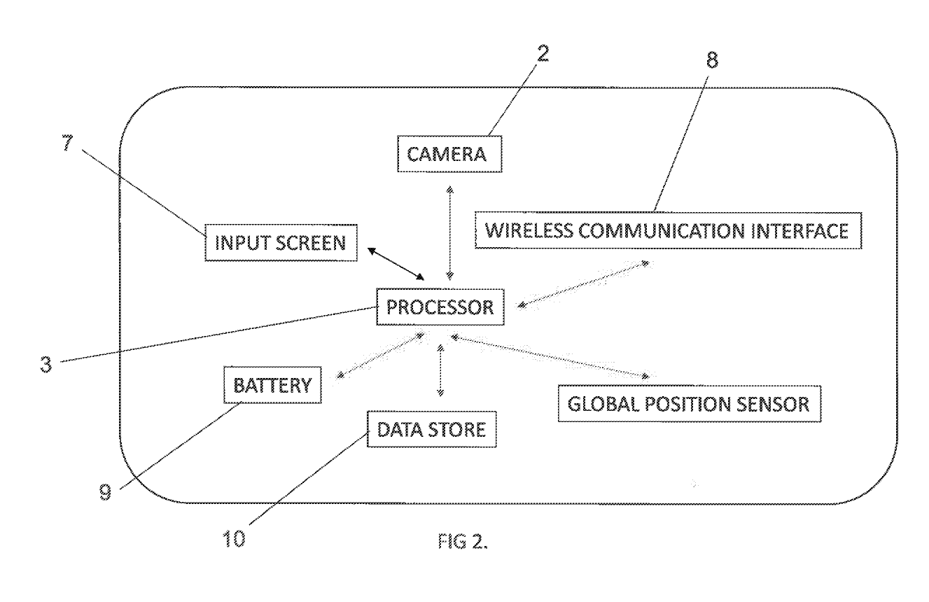

FIG. 1 shows part of a sensor activated system. In this embodiment, a sensor housing 1 takes the form of a mobile handheld unit. The sensor housing 1 may incorporate a camera 2, as shown in FIG. 2, whose functionality may be controlled by a processor 3. The camera 2 may incorporate a light sensitive sensor which may be activated by the processor to capture a particular scene viewed through the lens of the camera. In the embodiment of FIG. 1, a point of retail may be a shelf 4 located in a retail outlet of a particular retailer. Shelf 4 may stock a wide variety of products such as product 5. Product 5 may be available for immediate purchase at the retail outlet. In one embodiment, a passive tag is located physically adjacent to the physical object of a shelf of the retail outlet. An accompanying description and an image of the product may accompany the passive tag. The description of a specific product will then, in an embodiment, be different from the product displayed. By capturing an image of the passive tag, the mobile handheld unit will present an option to the user through a user interface such as an input screen 7 allowing the processor 3 to send the communication request through the wireless communication interface 8 to a first remote server which would return to the input screen specific product details associated with the specific passive tag.

In addition to the product details being presented, the specific point of retail is also identified in the input screen. An option of purchasing the presented specific product is then offered to the user. The completion of the purchase may be carried out by a user input into the input screen and recorded and processed in a first remote server carrying or associated with a purchasing system. Once the purchase has been completed a communication link is established between the first server associated with the purchasing system and the server of a brand owner to facilitate dispatch of the specific product to a destination specified by the user. Simultaneously, a further communication link may be provided between the first server and a third server corresponding to the retailer, whereby the retailer who has been championing the brand on behalf of the brand owner may simultaneously receive a notification of completion of a related purchase whilst at the same time the process of dispatching the specific product is initiated by the brand owner.

The term passive tag may incorporate an inductive winding capable of emitting a signal which is simultaneously representative of the product and of a point of retail. An alternative embodiment may employ a passive tag in the form of a plurality of pixels corresponding uniquely to a specific product and to a particular point of retail. This may take the form of an improved so called QR (quick response) code. This may also take the form of a Bluetooth™, Wi-Fi™ or infrared tag.

In a particular embodiment, once a pixelated image has been captured by a camera, an optical recognition system of known kind may be employed to determine signals representative of the specific product and the point of retail. The optical recognition system may identify that the plurality of pixels relate specifically to an alphanumeric code, or an alphabetic or numerical code. The alphanumeric code may for example be a code which has been generated by a computing engine which is incorporated in the application running on the first server. The first server may store a plurality of alphanumeric codes relating specifically to a product and to its point of retail. In other words, a specific entirely different code may relate to an identical product and relate at the same time to a different point of retail. In the event that the optical recognition system cannot determine the signal representative of a specific product and the point of retail, the system may provide one or more choices of potential matches which are determined by the general location or potential signal determined by the optical recognition system.

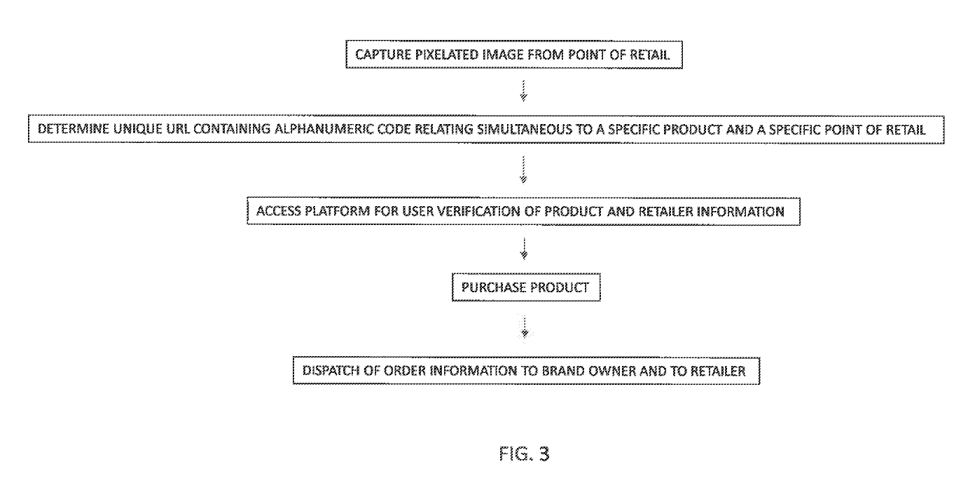

In use and as shown in FIG. 3, the process may derive from the plurality of pixels the alphanumeric code or other unique identifier and then associate it with a specific web address. This would result for example in a specific URL for example http://www.Website.com/b/d4bxpm. The processor 3 may be configured to automatically retrieve the website through the wireless communication interface to present on the input screen directly to a user the specific product in association with the point of retail as derived from the assessment of the passive tag.

Should a user confirm interest in purchasing the specifically identified product, a purchasing system may initiate a purchasing process and present various delivery options and fields for user input. Such processing systems are themselves well known in the art. They may include a data store located on the first server or any other secure facility to allow a user to readily access previous purchases and repeat a purchase without requiring the user to re-enter all the details. In such an embodiment, the system may provide monetary compensation to the specifically identified point of retail or retailer for both the initial purchase and any subsequent purchase. In a further embodiment, the processor and any other electronic equipment provided in the sensor housing may be powered by one or more battery cells such as battery 9. Furthermore, the mobile handheld unit may also incorporate its own local data store which may be associated specifically with the sensor or its camera in order to allow specific sensed signals to be saved for further processing. A data store 10 may provide for such storage. The processor may allow access to the data store 10 dependent upon specific user inputs. The input screen 7 may present the data stored in terms of specific images relating to a specific product and its associated point of retail. The presentation to the user may be in the form of a scrollable series of information packets which may be selectable through the input screen in order to direct the user to the purchasing system at a deferred time.

Embodiments of the invention maintain a data store for access by a user after a predetermined time has lapsed. This would be particularly advantageous in terms of allowing access to a first server on which a purchasing system is run for it to be accessible at an optimum point in time once a wireless communication interface is identified as functional. In preferred embodiments, a time delay of between 10 second and 10 minutes is preferred. In a further preferred embodiment, once a specific time delay has lapsed the system may be configured to once again seek connection with the purchasing system. The system may be set up to regularly seek connection until a user overrides the functionality.

In a further embodiment, the mobile handheld unit incorporates a global position sensor which may take the form of a gyroscope or cellular module which may be capable of triangulation with a plurality of satellites or other known wireless communication points in order to determine the geospatial coordinates of a particular handheld unit. The system also envisages correlating the determined geospatial coordinates to determine which particular point of retail has previously been associated with a predetermined range of geospatial coordinates. This embodiment would allow the passive tag option be only specific to the specific product in question and rely on the handheld unit to assess the likely point of retail. This potential embodiment may not be as accurate as the main embodiment which requires the signals derived from a passive tag or from a physical object itself to be simultaneously representative of the product and of a point of retail where detection was initiated. In that sense, the preferred embodiment employs less processing resource in the correct determination of the specific product and its point of retail than the secondary embodiment also provided in this description.

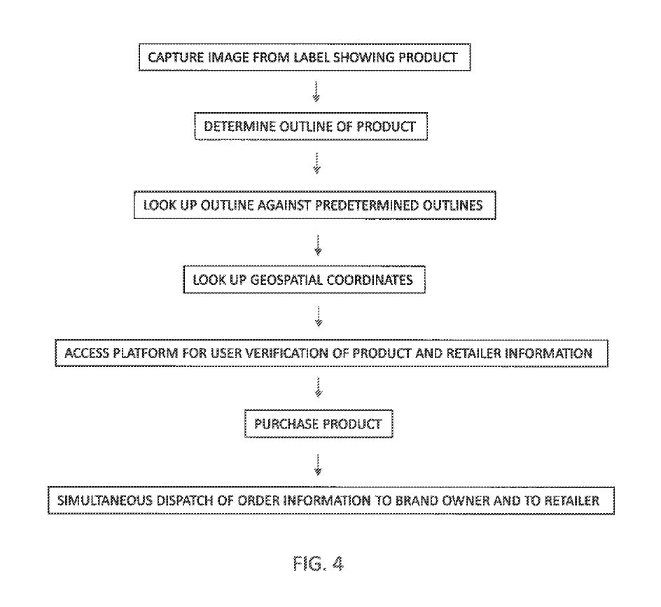

FIG. 4 shows a further alternative embodiment which allows the assessment of a physical object which may be a three dimensional object which may itself be a similar product. As explained previously, retail outlets are ideally equipped for promotion and for championing specific brands particularly when the user requires hands on assessment of a particular product before committing to a purchase. In order to improve methods of detection and systems relating to the delivery of specific products, the system may be configured to detect a physical object by capturing an image from a label showing the product or by capturing an image of the product itself, or by capturing and recognizing a retail outlet's logo. The system may thereafter determine the outline of a product and communicate with a first server which may be equipped with a plurality of potential product outlines and by geometric comparisons identify a match for a particular product outline. Once the system has looked up an outline as indicated in FIG. 4, it may look up geospatial coordinates available from the mobile handheld unit. Thereafter, the system may be configured to allow through the wireless communication interface access to a platform which may be hosted by a first server and which may provide a website with specific images relating to a specific product and a specific set of retailer information. Also the information may be verified by the user in terms of accuracy after which a purchasing module may be initiated to complete a purchase of the specific product. Once the product purchase has been completed communication links may be provided between a first server hosting the platform and a second server hosting the API (application program interface) of a brand owner in order to communicate and initiate the process of product delivery. Delivery may be arranged by either the brand owner or retail outlet. Simultaneously, in a preferred embodiment, a further communication is established between the first server of the platform and a third server corresponding to the API of a retailer or the retailer's electronic mail service to confirm the completion of a purchasing process.

It is envisaged that the system due to its inherent scalability and its virtuous potential rewards system for the retailers who champion the brands and the likely expansion of retailer networks with which brand owners would be interested in operating, that the system and methods of detection may be employed extensively across most retail outlets. As a consequence, the system envisages that a user may interact with several points of retail for a specific product.

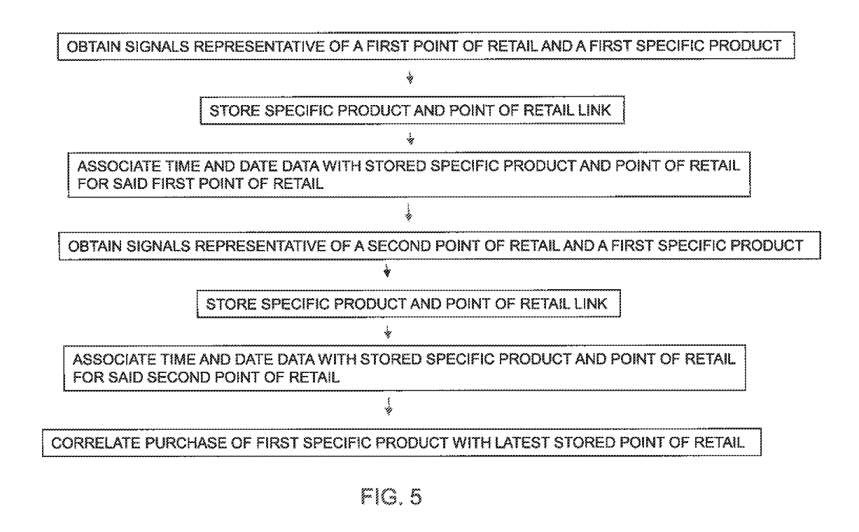

FIG. 5 applies to this potential set of circumstances. In a first step, signals may be obtained representative of a first point of retail and a first specific product. Thereafter, the data store may store a specific product and point of retail links. In addition to simply storing the first point of retail and the first specific product, this system is configured to associate a time and date variable with the stored specific product and point of retail. In the circumstances when a user obtains signals representative of a second point of retail or a further point of retail whilst still being associated with the identical first specific product, the system envisages storing the specific product and the point of retail link with a subsequent associated time and data stamp. Once the user initiates the purchase of the first specific product, a correlation system may be deployed in order to assess which store was the latest point of retail in order to weight the reward or compensation towards the latest retailer. The weighting may be inputted by the system operator to be biased 100% towards the retailer of the most recent interaction. An alternative embodiment envisages a different weighting for each one of the retailers from the most recent retailer to any predetermined number of previous retailers who may have contributed to the overall sale of the product to a given user.

Whilst the preceding embodiments have primarily referred to products these may be both goods and services dependent upon the application. In preferred embodiments, the products are goods rather than services.

It is well known that online retailers can often offer goods and/or services at lower prices than can physical ‘bricks and mortar’ stores. Online retailers do not have to cover such large overheads and can often also carry a wider stock than can a physical retailer. At least some embodiments as described herein address this imbalance and allow physical retailers to compete more readily with online retailers.

Within a retail environment, a retailer provides an identification code 100 which holds identification data about the product to which it relates. In the embodiment being described, the identification code is a QR code. However, in other embodiments any suitable form of identification code might be used such as a bar code; an RFID (Radio Frequency ID); a Near Field Communication (NFC), or any other suitable form of identification code that can be read by a machine.

Whilst in this further embodiment, the identification code is placed (step 200) within a bricks and mortar store, perhaps on a shelf 102, or the like, in other embodiments this need not be the case. In other embodiments, the identification code might be additionally, or alternatively, placed in a web-site; social media site; social media message; email; or any other suitable location. These may constitute additional examples of a point of retail.

Conveniently, and perhaps to draw the attention of a buyer, or potential buyer, an example of the goods 104 may be provided in association with the identification code 100. In the embodiment being described, the goods 104 are in fact a representation of the goods, such as a box, perhaps cardboard, on which marketing material is positioned.

In use, a user may use his or her electronic device 106 to scan, or otherwise read, the identification code 100. In this embodiment, the electronic device 106 is represented as a Smart phone (such as an iPhone™; an Android™; a Windows™ phone; a Blackberry™, or any other suitable device). However, any other form of device suitable for scanning the identification code 100 may be used. For example, the electronic device might also be a tablet (such as an iPad™ an Android™ tablet; a Windows™ tablet; a Blackberry™ tablet); a watch; a dedicated scanner; a laptop; or the like.

Scanning of the identification code 100 causes the electronic device to generate the identification data (step 202). The identification data may be generated from the identification code 100 itself, or in additional or alternative embodiments, the data held within the identification code 100 may act as a pointer (such as to a URL or the like) where the identification data can be obtained.

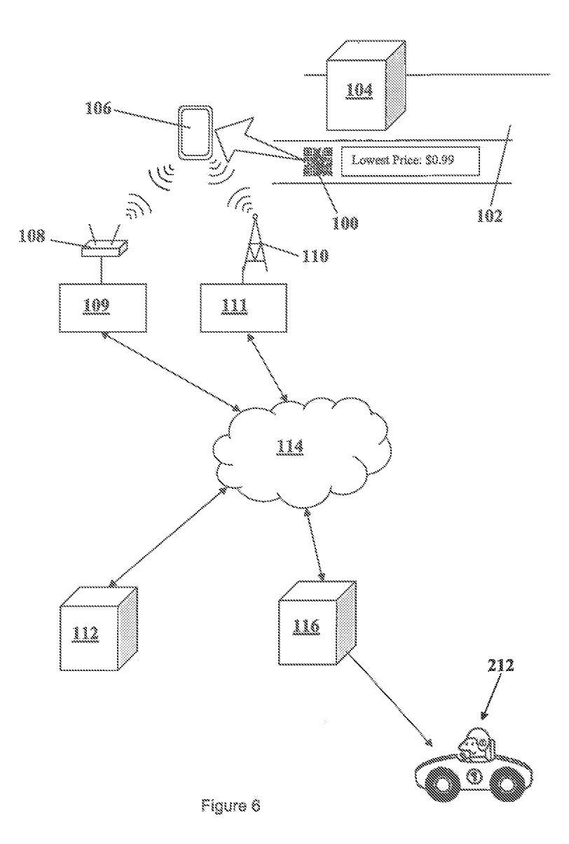

In FIG. 6, the electronic device 106 is shown as being connected to both a wireless router 108 and a cellular telephone data network 110. For example, the wireless router 108 may be creating a WIFI (such as IEEE802.11a/g/n/ac; Bluetooth; or the like). The cellular telephone data network might be any of the following: GSM; UMTS; 3G; 4G; 5G; Edge; or the like.

In the embodiment being described the identification data obtained from scanning the identification code 100 with the electronic device 106 is sufficient to identify the location and identify of the goods (eg those identified at 104) in which the user is interested.

Infrastructure associated with the wireless router 108 is represented as 109. Infrastructure associated with the cellular telephone network 110 is represented as 111.

A first server 112 is arranged to receive this identification data across a network connection thereto (step 204). Here the network connection is shown as being the Internet and World Wide Web (WWW) 114 operating TCP/IP and or SSL in order to connect the first server 112 to other devices. In other embodiments, the network connection may be any other form of suitable Wide Area Network (WAN) or Local Area Network (LAN).

The first server 112 is arranged to provide a web-site to present result data back to the user of the electronic device 106 (step 206). In other embodiment, the first server 112 may present the results in any other format and it need not be a web-site. The first server 112 could for instance generate a PDF or other format and send that to the user via an email or the like. However, embodiments presenting the result data are believed advantageous as they will be both familiar and convenient to a user.

The result data is present as an e-commerce web-site allowing a user to select his/her preferred source and/or price point for the goods 104 (s)he wishes to purchase.

The first server 112 may maintain a database of all the goods for which an identification code 100 exists within the system. However, in alternative or additional embodiments the first server 112 may be arranged to perform a search of the WWW 114 (or other network) to generate the set of result data for the goods 104. The search may also be a search of an external database.

In one particular embodiment, the first server 112 is arranged to highlight to a user of the web-site presented to the user the price at which the goods 104 may be obtained. Here highlighted means any suitable mechanism for drawing the price to the user. In most embodiments, the price is the same for every single retailer. In other embodiments, different prices may be provided, in such embodiments the results data may be automatically arranged to present the lowest/cheapest price first; only present the cheapest/lowest price; make the cheapest/lowest price flash; render the cheapest/lowest price in a different colour; or any suitable mechanism.

The web-site provided by the first server 112 is also arranged to provide a shopping cart to the user allowing the user to set up a purchase of the goods 104 from the supplier/price point selected by the user.

In a further embodiment, the first server 112 may also arrange the delivery of the goods 104 to a location specified by the user in the shopping cart process.

However, in another embodiment, the first server 112 has, in order to present the results data, performed a search to identify the cheapest retailer from which the goods may be purchased. Accordingly, once the user has completed the purchase process the first server 112 is arranged to generate order data to be sent to a second server 116 from which the goods 104 are obtainable. The order data may include any one or more of the following: payment data to pay the retailer running the second server 116; delivery data comprising an address to where the goods might be delivered.

Should the goods be available from multiple warehouses, at least one of the first and second servers determines which of those warehouses has the lowest cost function to deliver the goods. Here the lowest cost function may be proximity to the delivery destination (ie location specified by the user). However, the lowest cost function may also take into account ease of deliver—such as the expected amount of traffic, avoidance of toll roads, or the like. In other embodiments the system might make a decision as to which warehouse to use according to another parameter. It may for example in the driverless vehicle embodiment issue an instruction to the driverless vehicle to proceed to a particular collection point and carry out a delivery to a user.

During the checkout process, a user may be presented with a number of options as to where the goods should be delivered. For example, they may be able to have the goods delivered to the bricks and mortar (which may also be termed the affiliate) store from which they placed his/her order. Alternatively, the user may be able to specify to where the goods should be delivered.

In the embodiment being described, should the user decide that he or she wishes to have the goods delivered to the Affiliate then the first server may be arranged to send, or cause to be sent, notification data. This notification data may be sent via any suitable mechanism such as txt message; MMS message; email; Instant Messaging; telephone call (cellular or landline); Tweet; or the like. The notification data contains information to alert the purchaser of the goods that the goods are being delivered/have been ordered.

Finally, the goods 104 are then delivered according to the information held in the order data (step 212).

Once delivery of the goods has been arranged the first server 112 is arranged to generate payment data to instruct payment of the parties involved in the purchase of the goods 104.

In the embodiment being described, the parties to whom payment is sent are:
Agent who signed up the affiliate/retailer.
Affiliate/retailer/point of retail who sold to the consumer via the embodiments described above.
The warehouse/distributor who delivered the product

Thus, some embodiments may allow the brand/supplier to rebate the retailer (ie the affiliate) a commission for the introduction/sale to the consumer.

Should the goods be delivered to the Affiliate then the affiliate may cause arrival data to be sent to the first server 112 alerting the first server 112 of the arrival. The arrival data may be generated by staff at the affiliate logging onto a web-site hosted by the first server 112. Alternatively, or additionally, the arrival data may be generated by any other suitable means: scan a code, such as a QR code on the goods; sending an email; sending a txt; sending a tweet; or the like.

Once the first server 112 receives the arrival data it is arranged to send, or caused to be sent further notification data alerting the user that ordered the goods that the goods have arrived. The further notification data may take the form of any of those mentioned in relation to the notification data.

The skilled person will appreciate that whilst reference has been made to first 112 and second 116 servers that these may actually each comprise a plurality of machines which may be virtual or physical/real (or both).

1. A sensor system comprising a sensor housing, a sensor contained within said housing, said sensor being configured to detect one or more characteristics of a passive tag or of a physical object representative of a specific product optionally without being itself a product; wherein the sensor system further comprises a user interface, a data store for storing signals detected by said sensor, and a processor for processing said detected signals; said processor being further configured to present via said user interface the option of purchasing a specific product to the user of said sensor, said signals being simultaneously representative of the product and of a point of retail where detection was initiated, wherein said system further comprises a purchasing system for purchasing said specific product; and a communication link between said purchasing system and a brand owner who facilitates the dispatch of said specific product to a destination specified by the user of said sensor.

2. A sensor system according to claim 1, wherein upon a completion of a purchase, said system automatically communicates said completion to both the retailer associated with said point of retail and to the brand owner.

3. A sensor system according to claim 1, wherein said sensor incorporates a camera for capturing an image of said passive tag or of said object, and an optical recognition system for determining signals representative of said specific product and of said point of retail.

4. A sensor system according to claim 3, wherein said optical recognition system determines the shape of the perimeter of an object and matches it against a pre-determined shape.

5. A sensor system according to claim 3, wherein said image incorporates a plurality of pixels which correspond uniquely to a specific product and to a particular point of retail.

6. A sensor system according to claim 1, further comprising a global position sensor for determining the point of retail and said processor associates said determined point of retail with other characteristics representative of a specific product.

7. A sensor system according to claim 1, wherein said data store stores a plurality of signals detected by said sensor and allows the user interface to select any one of the specific products for purchasing after a predetermined time has lapsed since the determination of said specific product and its point of retail.

8. A sensor system according to claim 1, wherein said data store stores a plurality of signals detected by said sensor and presents the latest detected product and its most recently associated point of retail.

9. A driverless vehicle comprising a sensor system according to claim 1.

10. A method of detection comprising the steps of:
providing a sensor housing and a sensor contained within said housing;
detecting one or more characteristics of a passive tag or of a physical object representative of a specific product optionally without being itself a product;
providing a user interface, and a data store for storing signals detected by said sensor; said signals being simultaneously representative of the product and of a point of retail where detection was initiated;
processing said detected signals;
presenting via said user interface the option of purchasing a specific product to the user of said sensor;
providing a purchasing system for purchasing said specific product; and
causing said purchasing system to communicate via a communication link with a brand owner to facilitate the dispatch of said specific product to a destination specified by the user of said sensor.

11. A method of detection according to claim 10, comprising upon completion of a purchase, the further step of automatically communicating said completion to both the retailer associated with said point of retail and the brand owner.

12. A method of detection according to claim 11, comprising the further steps of capturing an image of said passive tag or of said object and employing optical recognition to determine signals representative of said specific product and of said point of retail.

13. A method according to claim 12, comprising the step of determining the shape of the perimeter of an object and matching it against a pre-determined shape.

14. A method according to claim 12, comprising the step of correlating the pixels of a capture image against a pre-determined dataset uniquely representative of both a specific product and its point of retail.

15. A method according to claim 10, further comprising the step of determining the position of said sensor in a set of geographic coordinates in order to determine said point of retail and associating said determined point of retail with said specific product.

16. A method according to claim 10, further comprising the steps of storing a plurality of signals detected by said sensor and allowing the user interface to select any one of the specific products for purchasing after a predetermined time has lapsed since the determination of said specific product and its point of retail.

17. A method according to claim 10, further comprising the steps of storing a plurality of signals detected by said sensor and presenting the latest detected product and its most recently associated point of retail.

18. A method of delivering goods to a user comprising the following steps:
receiving at a first server identification data containing the identity of goods that a user wishes to acquire;
causing the first server to return results data providing one or more sources from which the goods can be obtained;
causing the first server to present a shopping cart to the user from which the user can arrange a purchase of the goods; and
causing the first server to communicate with a second server by sending order data thereto.

19. The method of claim 18, wherein the identification data comprises any of the following: the identification of the goods; the location at which the identification data was received.

20. The method of claim 18 in which, in order to present the results data to the user, the first server is arranged to perform a search to locate the goods.

21. The method of claim 18 in which, in order to present the results data to the user, the first server uses a database to which it has access.

22. The method of claim 18 in which the order data specifies the address to which the goods should be sent.

23. A server arranged to provide the method of claim 18.

24. A non-transitory machine readable medium containing instructions which when read by a computer cause that computer to perform as the first server.
